(19) United States
(12) Patent Application Publication
(10) Pub. No.: US 2009/0303875 A1
(43) Pub. Date: Dec. 10, 2009

(54) CONGESTION CONTROL SYSTEM, CALL SESSION CONTROL DEVICE, BORDER GATEWAY DEVICE, AND CONGESTION CONTROL METHOD USED THEREFOR

(76) Inventor: Kenji MATSUMURA, Tokyo (JP)

Correspondence Address: Mr. Jackson Chen, 6535 N. STATE HWY 161, IRVING, TX, 75039, US

(21) Appl. No.: 12/477,787

(22) Filed: Jun. 3, 2009

(30) Foreign Application Priority Data
Jun. 4, 2008 (JP) 2008-146354

(51) Int. Cl. H04L 12/26; H04L 12/66

(52) U.S. Cl. 370/230; 370/352

(57) ABSTRACT

A congestion control system according to an exemplary aspect of the present invention includes an SIP (Session Initiation Protocol) terminal of a subscriber; a call session control device that accommodates the subscriber using SIP, and includes a notification unit that inserts server information of the call session control device including at least an acceptable number of calls in an SIP response message; and a border gateway device that includes a control device of VoIP (Voice over Internet Protocol) services, and a congestion control unit that performs congestion control for the call session control device based on the server information of the SIP response message notified by the call session control.

### INCORPORATION BY REFERENCE

This application is based upon and claims the benefit of priority from Japanese patent application No. 2008-146354, filed on Jun. 4, 2008, the disclosure of which is incorporated herein in its entirety by reference.

### BACKGROUND OF THE INVENTION

1. Technical Field

The present invention relates to a congestion control system, a call session control device, a border gateway device, and a congestion control method used therefor and, in particular, to congestion in the call session control device which includes call session control function (CSCF) arranged concentratedly in a VoIP (Voice over Internet Protocol) network.

2. Background Art

Unlike in a conventional switch-based telephone network, in a VoIP network, call session control devices for accommodating subscribers are arranged not distributedly but concentratedly. Additionally, each call session control device accommodates much more subscribers than in a conventional switch board, and subscriber information in various areas is mixed therein. Hence, when a failure such as congestion occurs, influence thereof extends over a wide area.

In the VoIP network using SIP (Session Initiation Protocol), the call session control devices for accommodating subscribers are arranged concentratedly. Hence, when a large number of phone calls occur, SIP packets concentrate on the call session control device. As a result, the call session control device gets into a congestion state, and phone call becomes hard to be connected or fails to be connected.

At this time, subscribers do not know what has happened, and therefore take actions such as calling back repeatedly, and as a result, the congestion state gets worse. For that reason, the congestion state influences a whole VoIP system, and recovery requires considerable time.

Consequently, a state of the call session control device is monitored, and if the load of the call session control device increases, it is necessary for a border gateway device which includes border gateway function (BGF) to change a transmission destination of the SIP packets and thereby distribute the load of the call session control device, or regulate an amount of connection.

Means by which the border gateway device detects a state of the call session control device includes the following cases:

(1) a case where it is monitored how many SIP packets the border gateway device sends to the call session control device, and then, the state thereof is estimated,

(2) a case where the call session control device generates a dedicated packet, and thereby notifies the state of its own to the border gateway device, and

(3) a case where a state management server for the call session control device is installed separately from the call session control device to thereby collect the state of the call session control device, and notifies it to the border gateway device.

Systems corresponding to the above-described cases (1) to (3), as shown in FIG. 7, include a system configured such that congestion monitors 7-1 to 7-n are respectively connected to border gateway devices (represented as BGD in FIG. 7) 5-1 to 5-n (n is a positive integer) under which SIP terminals 3-1 to 3-x (x is a positive integer, and x>n) are arranged, and further, a congestion management server 6 (state management server) is connected to the call session control devices (represented as CSCD in FIG. 7) 4-1 to 4-m (m is a positive integer) connected to the border gateway devices 5-1 to 5-n through a VoIP network 100.

Meanwhile, Japanese Unexamined Patent Application Publication No. 2007-189509, disclosed a method in which congestion control can be performed in a VoIP network composed of a plurality of IP (Internet Protocol) terminals connected through a transmission path such as the Internet and using a connectionless type of UDP (User Datagram Protocol).

In this congestion control method described in Japanese Unexamined Patent Application Publication No. 2007-189509, a call session control device is provided with an overload information reception unit for receiving overload information indicating that the transmission path is in an overloaded state, and a control unit for controlling to forbid transfer of an establishment request for a session to a second IP terminal when the overload information reception unit receives the overload information, even if a connection request reception unit receives the establishment request for the new session from a first IP terminal to the second IP terminal.

The present inventors have found a problem that in the VoIP network relevant to the present invention, in the above-described case (1), there exists a plurality of border gateway devices for sending the SIP packets to one call session control device, so that it is difficult to estimate a state of the call session control device only with one border gateway device.

Additionally, the present inventors have found a problem that in the VoIP network relevant to the present invention, in the above-described case (2), it is necessary for the call session control device to generate/send the dedicated packet to notify a state of its own in the device itself, so that load of the call session control device increases, and useless traffic flows also on the network.

Further, the present inventors have found a problem that in the VoIP network relevant to the present invention, in the above-described case (3), the state management server is installed separately, so that an investment amount for the system increases. In this case, there is a problem that the state management server cannot grasp the state of the call session control device in real time.

Meanwhile, since also in the method described in the above-described Japanese Unexamined Patent Application Publication No. 2007-189509, dedicated packet communication must be performed in order to notify the congestion state as well as in the above-described case (2), there is a problem of causing an unnecessary increase in traffic, time lag of information, etc.

### SUMMARY

An exemplary object of the present invention is to provide a congestion control system, a call session control device, a border gateway device, and a congestion control method used therefor, in which the above-described problems can be solved, and a measure of congestion avoidance can be quickly taken at the time of load increase of the call session control device, and as a result, an influence on the whole VoIP network can be suppressed.

A congestion control system according to an exemplary aspect of the present invention includes an SIP (Session Initiation Protocol) terminal of a subscriber; a call session control device that accommodates the subscriber using SIP, and includes a notification unit that inserts server information of the call session control device including at least an acceptable number of calls in an SIP response message; and a border gateway device that includes a control device of VoIP (Voice over Internet Protocol) services, and a congestion control unit that performs congestion control for the call session control device based on the server information of the SIP response message notified by the call session control.

A call session control device according to an exemplary aspect of the present invention, the call session control device used for a congestion control system including a call session control device for an accommodating subscriber using SIP (Session Initiation Protocol), a border gateway device including a control device of VoIP (Voice over Internet Protocol) services, and an SIP terminal of the subscriber, the call session control device includes a message management unit that generates an SIP response message including server information of the call session control device inserted therein, the server information including at least an acceptable number of calls; and a communication unit that transmits the message to the border gateway device.

A border gateway device according to an exemplary aspect of the present invention, the border gateway device used for a congestion control system including a call session control device for an accommodating subscriber using SIP (Session Initiation Protocol), a border gateway device including a control device of VoIP (Voice over Internet Protocol) services, and an SIP terminal of the subscriber, the border gateway device includes a network communication unit that receives from the call session control device an SIP response message having server information inserted therein, the sever information including at least an acceptable number of calls; and a server control unit that performs congestion control for the call session control device based on the server information.

A congestion control method according to an exemplary aspect of the present invention, the congestion control method used for a system including a call session control device for an accommodating subscriber using SIP (Session Initiation Protocol), a border gateway device having a control device of VoIP (Voice over Internet Protocol) services, and an SIP terminal of the subscribers, the congestion control method includes inserting server information of the call session control device including at least an acceptable number of calls in an SIP response message to be notified to the border gateway device; and performing congestion control for the call session control device based on the server information.

According to an exemplary aspect of the present invention, a computer readable recording medium having a program recorded thereon for notifying a message by a call session control device used for a congestion control system including a call session control device for an accommodating subscriber using SIP (Session Initiation Protocol), a border gateway device having a control device of VoIP (Voice over Internet Protocol) services, and an SIP terminal of the subscriber, the recording medium having a program recorded thereon for causing a computer to execute message generation processing for generating an SIP response message including server information of the call session control device inserted therein, the server information including at least an acceptable number of calls; and communication processing for transmitting the message to the border gateway device.

According to an exemplary aspect of the present invention, a computer readable recording medium having a program recorded thereon according to an exemplary aspect of the present invention for controlling congestion by a border gateway device used for a congestion control system including a call session control device for an accommodating subscriber using SIP (Session Initiation Protocol), a border gateway device having a control device of VoIP (Voice over Internet Protocol) services, and an SIP terminal of the subscriber, the recording medium having a program recorded thereon for causing a computer to execute network communication processing for receiving from the call session control device an SIP response message including server information inserted therein, the server information including at least an acceptable number of calls; and server control processing for performing congestion control for the call session control device based on the server information.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a block diagram showing a configuration example of a congestion control system according to a first exemplary embodiment of the present invention;

FIG. 2 is a block diagram showing a configuration example of the border gateway device according to the first exemplary embodiment of the present invention;

FIG. 3 is a block diagram showing a configuration example of the call session control device according to the first exemplary embodiment of the present invention;

FIG. 4 is an illustration showing one example of an extended format of the SIP response message in the first exemplary embodiment of the present invention;

FIG. 5 is a table showing one example of a stored format of server information held in the server information table 231 in the congestion control unit 23 shown in FIG. 3;

FIG. 6 is a sequence chart showing an operation example at the time of session establishment in the first exemplary embodiment of the present invention; and

FIG. 7 is a block diagram showing a configuration example of a congestion control system according to a related art of the present invention.

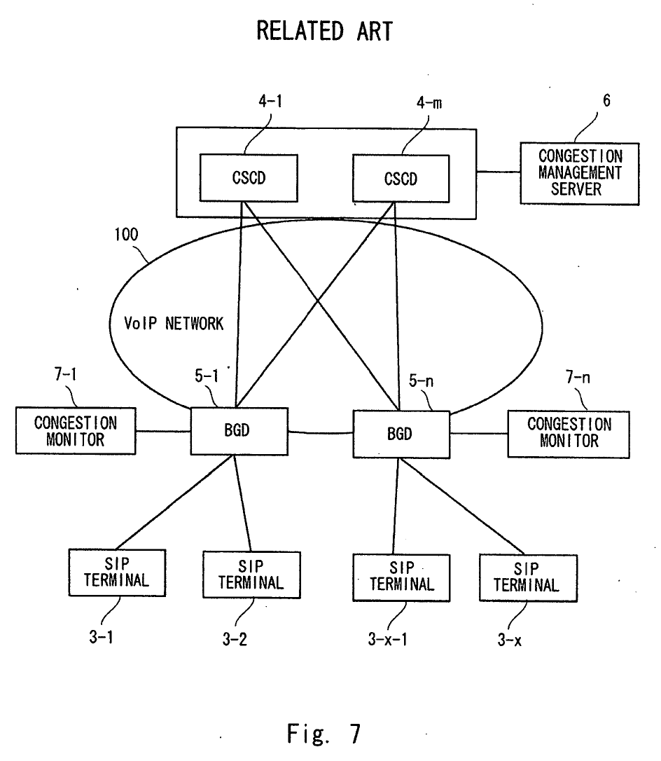

### EXEMPLARY EMBODIMENT

Next, exemplary embodiments of the present invention will be explained with reference to the drawings. First, an outline of a congestion control system according to an exemplary embodiment of the present invention will be explained. The congestion control system according to an exemplary embodiment of the present invention allows for congestion control with a border gateway device by notifying a state of a call session control device to the border gateway device in real time without loading the call session control device or the network in a VoIP (Voice over Internet Protocol) network including call session control devices, border gateway devices, and SIP (Session Initiation Protocol) terminals.

The call session control device accommodates subscribers using the SIP. The border gateway device is arranged at a network edge (border), and each have a control device of VoIP services, such as an SBC (Session Border Controller) device.

Consequently, in the congestion control system according to an exemplary embodiment of the present invention, the state of the call session control device is notified to the border gateway device in real time using an SIP response message to transmit from the call session control device to the border gateway device. Specifically, the SIP response message is extended, and server information of the call session control device is inserted therein. The server information includes at least CPU (Central Processing Unit) utilization, an acceptable number of calls, etc. As a result, the border gateway device allows for state detection of the call session control device in real time, and thereby allows for sufficient congestion avoidance control.

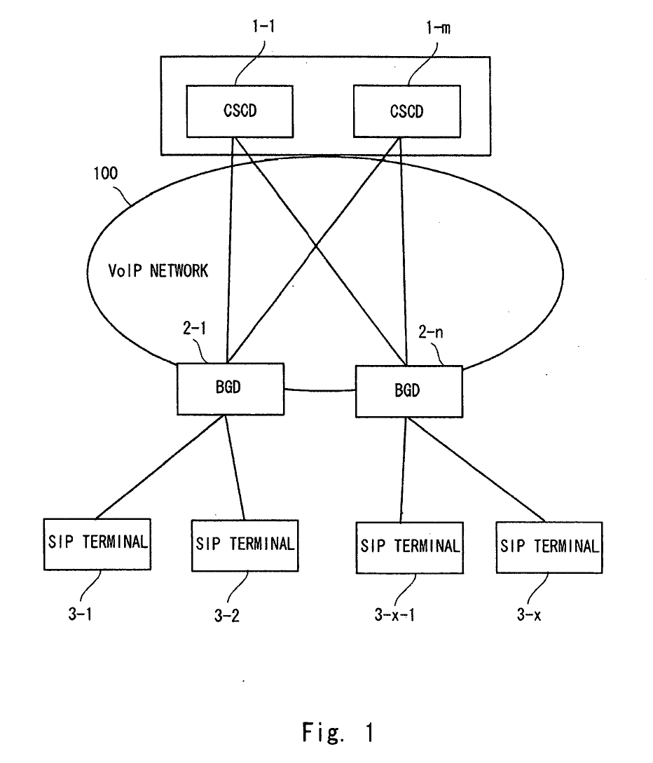

FIG. 1 is a block diagram showing a configuration example of a congestion control system according to a first exemplary embodiment of the present invention. In FIG. 1, the congestion control system according to the first exemplary embodiment of the present invention includes CSCDs (Call Session Control Devices) 1-1 to 1-m (m is a positive integer) for accommodating subscribers, BGDs (Border gateway devices) 2-1 to 2-n (n is a positive integer, and n<x), SIP terminals 3-1 to 3-x (x is a positive integer), and a VoIP network 100. Hereinafter CSCD is referred to as call session control device, and BGD is referred to as border gateway device. Each of call session control devices includes call session control function. Each of border gateway devices includes border gateway function.

Each of the border gateway devices 2-1 to 2-n has a control device of VoIP services, such as an SBC device, and selects one or plurality of the call session control devices 1-1 to 1-m for transferring SIP messages depending on loaded states of the call session control devices 1-1 to 1-m to then accommodate the SIP terminals 3-1 to 3-x therein.

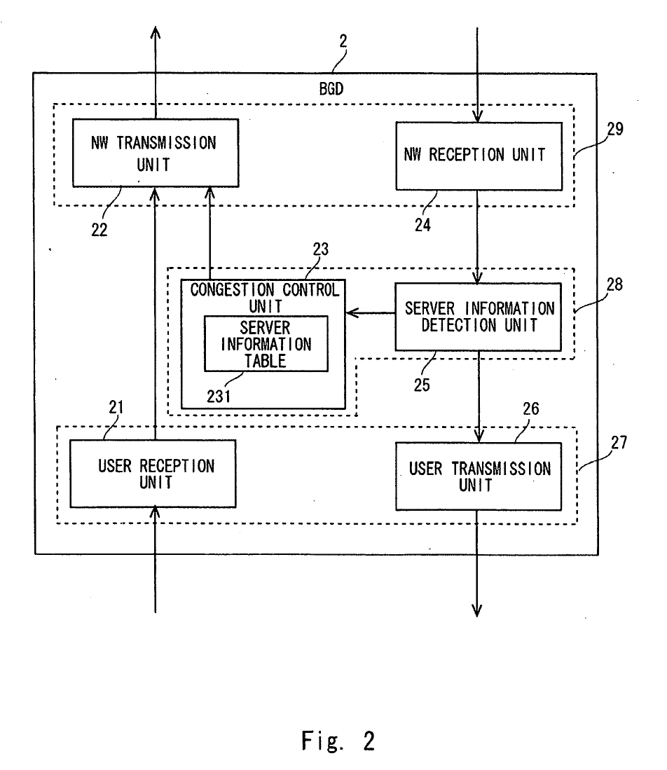

FIG. 2 is a block diagram showing a configuration example of the border gateway device according to the first exemplary embodiment of the present invention. In FIG. 2, a border gateway device 2 includes a USER reception unit 21, an NW (NetWork) transmission unit 22, a congestion control unit 23, an NW reception unit 24, a server information detection unit 25, and a USER transmission unit 26. Note that each of the border gateway devices 2-1 to 2-n shown in FIG. 1 has a similar configuration to the border gateway device 2.

The USER reception unit 21 receives SIP messages from the SIP terminals housed in the border gateway device 2. The NW transmission unit 22 transfers the SIP messages to the call session control devices 1-1 to 1-m in accordance with instructions of the congestion control unit 23.

The congestion control unit 23 determines whether server information received from the call session control devices 1-1 to 1-m exceeds or not preset thresholds and whether the server information shifts or not to a direction exceeding the thresholds, thereby preventing transfer to the call session control devices 1-1 to 1-m in which congestion has already occurred or congestion is likely to occur. Additionally, the congestion control unit 23 is provided with a server information table 231 for storing the server information received from the call session control devices 1-1 to 1-m.

The NW reception unit 24 receives SIP response messages from the call session control devices 1-1 to 1-m. The server information detection unit 25 extracts the server information from the SIP response messages received from the call session control devices 1-1 to 1-m, and sends it to the congestion control unit 23. The USER transmission unit 26 sends the SIP response messages received from the call session control devices 1-1 to 1-m to the SIP terminals housed in the border gateway device 2.

Additionally, in FIG. 2, the border gateway device 2 is, in other words, provided with a USER communication unit 27 including the USER reception unit 21 and the USER transmission unit 26, a server control unit 28 including the congestion control unit 23 and the server information detection unit 25, and an NW communication unit (NetWork communication unit) 29 including the NW transmission unit 22 and the NW reception unit 24. Among them, a congestion control unit is realized using the server control unit 28 and the NW communication unit 29.

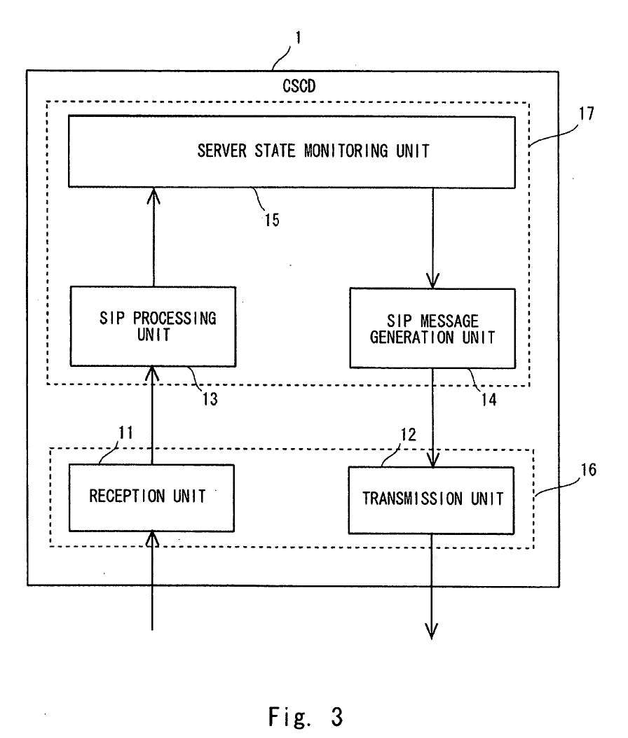

FIG. 3 is a block diagram showing a configuration example of the call session control device according to the first exemplary embodiment of the present invention. In FIG. 3, a call session control device 1 includes a reception unit 11, a transmission unit 12, an SIP processing unit 13, an SIP message generation unit 14, and a server state monitoring unit 15.

Note that the call session control device 1 is provided with a CPU and a storage unit for storing a program executed by the CPU, which are not shown. Additionally, each of the call session control devices 1-1 to 1-m shown in FIG. 1 has a similar configuration to the above-described call session control device 1.

The reception unit 11 receives SIP messages from the border gateway devices 2-1 to 2-n. The transmission unit 12 transmits SIP response messages to the border gateway devices 2-1 to 2-n.

The SIP processing unit 13 processes the received SIP messages. The SIP message generation unit 14 generates the SIP response messages based on information from the server state monitoring unit 15 along with results from the SIP processing unit 13. The server state monitoring unit 15 monitors a CPU load factor and an acceptable number of calls of the call session control device 1, and notifies them to the SIP message generation unit 14.

Additionally, in FIG. 3, the call session control device 1 is, in other words, provided with, a communication unit 16 including the reception unit 11 and the transmission unit 12, and a message management unit 17 including the SIP processing unit 13, the SIP message generation unit 14, and the server state monitoring unit 15. A notification unit is realized using the communication unit 16 and the message management unit 17.

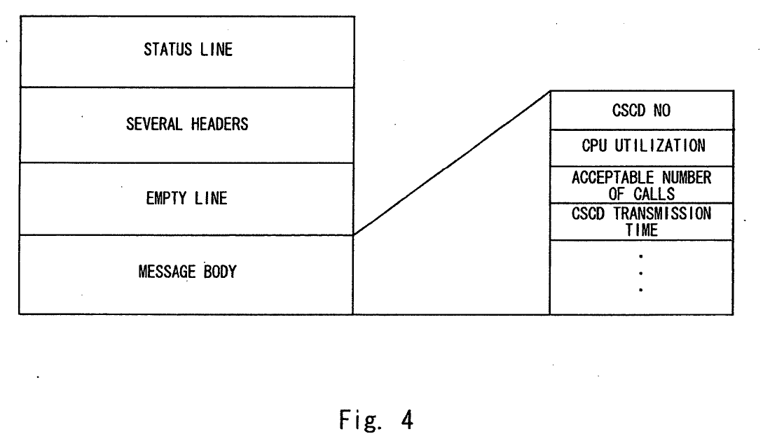

FIG. 4 is an illustration showing one example of an extended format of the SIP response message in the first exemplary embodiment of the present invention. FIG. 4 shows one example of the extended format of the SIP response message, which any one of the call session control devices 1-1 to 1-m transmits, and then any one of the border gateway devices 2-1 to 2-n (reception unit 24) receives.

The SIP response message includes a Status Line in which an SIP version and a Status code are described, Several Headers in which various headers are described, a null Empty Line, and a Message Body in which an option is described.

In the present exemplary embodiments, parameters, such as CPU utilization, an acceptable number of calls, and a CSCD transmission time in any one of the call session control devices 1-1 to 1-m, are added to the Message Body, which is an option area. Additionally, it is also possible to define a new header to thereby add a parameter in a Several Headers area.

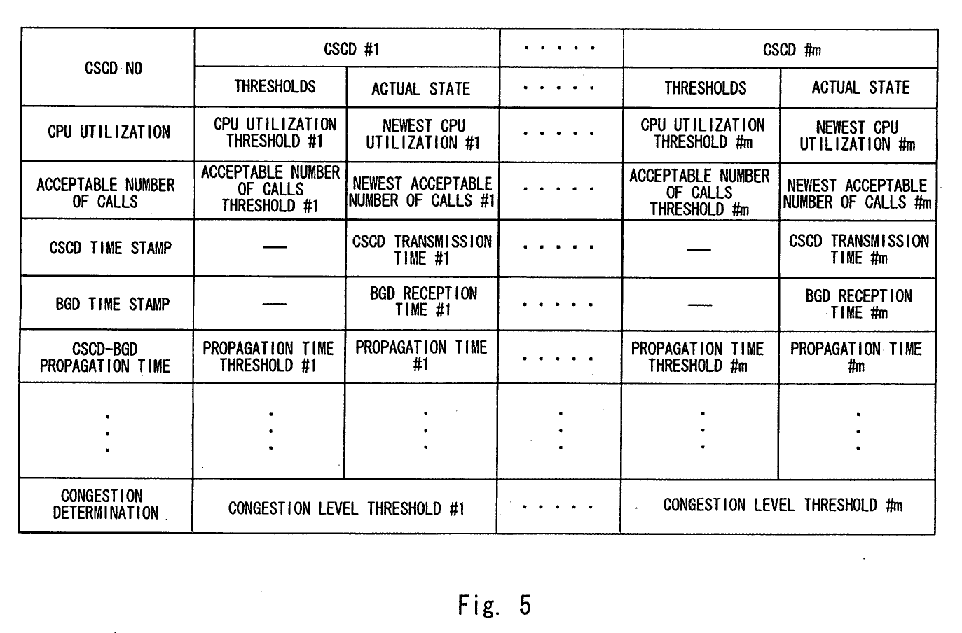

FIG. 5 is a table showing one example of a stored format of server information held in the server information table 231 in provided the congestion control unit 23 shown in FIG. 3. In FIG. 5, the congestion control unit 23 stores various parameters indicating congestion states of the call session control devices 1-1 to 1-m, which are notified via the SIP response messages, thresholds preset with respect to these various parameters, and congestion determination in the server information table 231.

The above-described various parameters include CPU utilization, an acceptable number of calls, a CSCD Time Stamp, a BGD Time Stamp, and a CSCD-BGD propagation time.

The congestion control unit 23 compares the server information notified from the call session control devices 1-1 to 1-m with the above-described thresholds, and then determines whether congestion occurs or not in the corresponding call session control devices 1-1 to 1-m depending on the threshold-exceeding states.

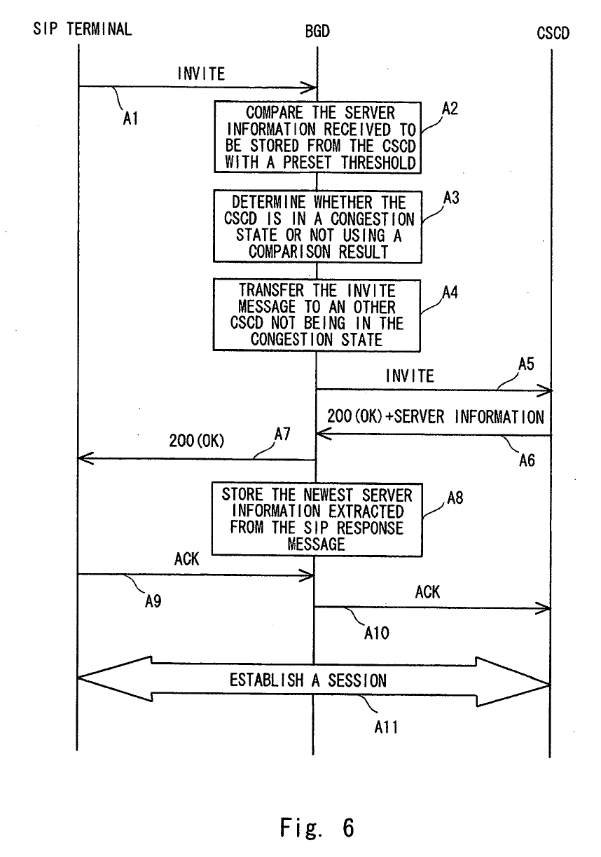

FIG. 6 is a sequence chart showing an operation example at the time of session establishment in the first exemplary embodiment of the present invention. The operation example at the time of session establishment in the first exemplary embodiment of the present invention will be explained with reference to FIG. 6. Note that herein, explanation for an operation of the control device of the VoIP services, such as the SBC device, is omitted.

From the SIP terminal, an INVITE message is sent to the border gateway device for session establishment (A1 in FIG. 6). Upon receiving the INVITE message, the border gateway device compares the server information received to be stored from the call session control device with a preset threshold (A2 in FIG. 6), and then determines whether the server information exceeds the threshold or not, i.e., the call session control device is in a congestion state or not using a comparison result (A3 in FIG. 6).

If the corresponding call session control device is in the congestion state, the border gateway device transfers the INVITE message to another call session control device not being in the congestion state (A4 and A5 in FIG. 6).

Upon receiving the INVITE message, if a connection request is acceptable, the call session control device performs acceptance processing, and inserts a response code “200” indicating O. K. and server information in an SIP response message to then send it to the border gateway device (A6 in FIG. 6). In this case, the server information is a CPU utilization A, an acceptable number of calls B, etc. at the time.

The border gateway device extracts the server information in the SIP response message received from the call session control device, and then transfers the SIP response message to an SIP terminal (A7 in FIG. 6). The border gateway device stores the newest server information extracted from the SIP response message in the server information table 231 provided in a congestion control unit 23 (A8 in FIG. 6).

When ACK (ACKnowledgement) with respect to the SIP response message is received from the SIP terminal (A9 in FIG. 6), the border gateway device transfers the ACK to the call session control device (A10 in FIG. 6), so that a session is established between the SIP terminal and the call session control device (A11 in FIG. 6).

When a state of the call session control device is detected from the received server information and if values of the CPU utilization A and the acceptable number of calls B exceed the preset thresholds, the border gateway device, from the next time, transfers a connection request from the SIP terminal to the corresponding call session control device to another call session control device whose server information does not exceed the threshold.

As described above, in an exemplary embodiment, since the state of the call session control device can be detected in real time, it becomes possible to immediately take a measure for congestion avoidance at the time of load increase of the call session control device, thus enabling to suppress an influence on the whole VoIP network 100.

Additionally, in an exemplary embodiment, since independent monitor means, such as a congestion management server, need not be taken, it becomes possible to suppress an increase in investment in construction of the VoIP network 100.

Further, in an exemplary embodiment, since server information is mechanically inserted in all the SIP response messages, processing in the call session control device can be more easily performed than in a case where a dedicated packet is generated/sent by the call session control device, and also network load decreases.

It is to be noted that the server information inserted in the SIP response message includes, the CPU utilization A, the acceptable number of calls B, etc., but if maintenance information of the call session control device is put in the SIP response message, and message transfer to the corresponding call session control device is not performed during maintenance, maintenance of the call session control device can be easily performed.

Additionally, in the above-described exemplary embodiment of the present invention, only the INVITE message is described, but if a similar operation to the above is performed with respect to all the SIP messages and the SIP response messages or only with respect to a specific message, it is also possible to suppress the load on the whole system.

Further, in the present invention, if the border gateway device sends an OPTIONS message etc. to the call session control device in which congestion has occurred at a certain cycle, and continuously obtains the server information appended to the SIP response message with respect to the OPTIONS message, and thereby determines a transition of the congestion state (congestion continuance or congestion relief) of the corresponding call session control device, it is also possible to send the SIP message again in a case of congestion relief.

Additionally, devices that the call session control device and the border gateway device explained in the each above-described exemplary embodiment execute can be realized using a program. The program can be recorded on a computer readable recording medium. Additionally, instruction sets constituting the program are loaded in memories provided in the call session control device and the border gateway device, and then the instruction sets are executed under CPU control.

A program for realizing a device that the call session control device notifies a message includes the instruction set for carrying out at least the following processing: (1) message generation processing for generating the SIP response message in which server information of the call session control device including at least the acceptable number of calls is inserted, and (2) communication processing for transmitting the message to the border gateway device.

Additionally, a program for realizing a device that the border gateway device controls congestion includes the instruction set for carrying out at least the following processing: (1) network communication processing for receiving from the call session control device the SIP response message in which server information including at least the acceptable number of calls is inserted, and (2) server control processing for performing congestion control with respect to the call session control device based on the server information.

Since the present invention provides the above-described configurations and operations, the measure for congestion avoidance can be immediately taken at the time of load increase of the call session control device, and such an advantageous effect can be obtained that the influence on the whole VoIP network can be suppressed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A congestion control system comprising:
an SIP (Session Initiation Protocol) terminal of a subscriber;
a call session control device that accommodates the subscriber using SIP, and includes a notification unit that inserts server information of the call session control device including at least an acceptable number of calls in an SIP response message and
a border gateway device that includes a control device of VoIP (Voice over Internet Protocol) services, and a congestion control unit that performs congestion control for the call session control device based on the server information of the SIP response message notified by the call session control.

2. The congestion control system according to claim 1, wherein the congestion control unit compares the server information with a threshold preset corresponding thereto, and determines whether congestion occurs or not in a corresponding call session control device based on a comparison result.

3. The congestion control system according to claim 2, the congestion control unit transfers a connection request from the SIP terminal to another call session control device whose server information does not exceed the threshold, when the server information exceeds the threshold.

4. The congestion control system according to claim 1, wherein
the notification unit notifies the border gateway device of maintenance information of the call session control device as the server information, and
the congestion control unit performs the congestion control depending on the maintenance information.

5. The congestion control system according to claim 1, wherein the congestion control unit continuously obtains the server information, and determines a transition of a congestion state indicating whether the congestion in the call session control device continues or is relieved.

6. A call session control device used for a congestion control system including a call session control device for an accommodating subscriber using SIP (Session Initiation Protocol), a border gateway device including a control device of VoIP (Voice over Internet Protocol) services, and an SIP terminal of the subscriber, the call session control device comprising:
a message management unit that generates an SIP response message including server information of the call session control device inserted therein, the server information including at least an acceptable number of calls; and
a communication unit that transmits the message to the border gateway device.

7. The call session control device according to claim 6, wherein the message management unit inserts maintenance information of the call session control device as the server information in the SIP response message.

8. A border gateway device used for a congestion control system including a call session control device for an accommodating subscriber using SIP (Session Initiation Protocol), a border gateway device including a control device of VoIP (Voice over Internet Protocol) services, and an SIP terminal of the subscriber, the border gateway device comprising:
a network communication unit that receives from the call session control device an SIP response message having server information inserted therein, the sever information including at least an acceptable number of calls; and
a server control unit that performs congestion control for the call session control device based on the server information.

9. The border gateway device according to claim 8, wherein the server control unit compares the server information with a threshold preset corresponding thereto, and determines whether congestion occurs or not in a corresponding call session control device based on a comparison result.

10. The border gateway device according to claim 9, wherein when the server information exceeds the threshold, the server control unit transfers a connection request from the SIP terminal to another call session control device whose server information does not exceed the threshold.

11. The border gateway device according to claim 8, wherein the server control unit performs the congestion control depending on the maintenance information, when maintenance information of the call session control device is notified as the server information.

12. The border gateway device according to claim 8, wherein the server control unit continuously obtains the server information, and determines a transition of a congestion state indicating whether the congestion of the call session control device continues or is relieved.

13. A congestion control method used for a system including a call session control device for an accommodating subscriber using SIP (Session Initiation Protocol), a border gateway device having a control device of VoIP (Voice over Internet Protocol) services, and an SIP terminal of the subscribers, the congestion control method comprising:
inserting server information of the call session control device including at least an acceptable number of calls in an SIP response message to be notified to the border gateway device; and
performing congestion control for the call session control device based on the server information.

14. The congestion control method according to claim 13, wherein the congestion control includes comparing the server information with a threshold preset corresponding thereto, and determining whether congestion occurs or not in a corresponding call session control device based on a comparison result.

15. The congestion control method according to claim 14, wherein the congestion control includes transferring a connection request from the SIP terminal to another call session control device whose server information does not exceed the threshold, when the server information exceeds the threshold.

16. The congestion control method according to claim 13, wherein the congestion control includes controlling the congestion depending on the maintenance information, when maintenance information of the call session control device is notified as the server information.

17. The congestion control method according to claim 13, wherein the congestion control includes continuously obtaining the server information, and determining a transition of a congestion state indicating whether the congestion of the call session control device continues or is relieved.

18. A computer readable recording medium having a program recorded thereon for notifying a message by a call session control device used for a congestion control system including a call session control device for an accommodating subscriber using SIP (Session Initiation Protocol), a border gateway device having a control device of VoIP (Voice over Internet Protocol) services, and an SIP terminal of the subscriber, the recording medium having a program recorded thereon for causing a computer to execute:
message generation processing for generating an SIP response message including server information of the call session control device inserted therein, the server information including at least an acceptable number of calls; and
communication processing for transmitting the message to the border gateway device.

19. A computer readable recording medium having a program recorded thereon for controlling congestion by a border gateway device used for a congestion control system including a call session control device for an accommodating subscriber using SIP (Session Initiation Protocol), a border gateway device having a control device of VoIP (Voice over Internet Protocol) services, and an SIP terminal of the subscriber, the recording medium having a program recorded thereon for causing a computer to execute:
network communication processing for receiving from the call session control device an SIP response message including server information inserted therein, the server information including at least an acceptable number of calls; and
server control processing for performing congestion control for the call session control device based on the server information.
